(19) United States
(12) Patent Application Publication
(10) Pub. No.: US 2015/0023865 A1
(43) Pub. Date: Jan. 22, 2015

(54) REACTIVE PROCESS FOR OBTAINING SYNTHETIC BARIUM SULFATE AND CALCIUM CHLORIDE

(71) Applicant: Gabriela CASTILLO GALLEGOS, Monterrey (MX)

(72) Inventor: Gabriela CASTILLO GALLEGOS, Monterrey (MX)

(73) Assignee: NEXTBAR, SA DE CV, Santa Catarina (MX)

(21) Appl. No.: 14/036,475

(22) Filed: Sep. 25, 2013

(30) Foreign Application Priority Data
Jul. 17, 2013 (MX) MX/A/2013/008316

(51) Int. Cl. C01F 11/46; C01F 11/28

(52) U.S. Cl. CPC C01F 11/462; C01F 11/28
USPC 423/497; 423/554

(57) ABSTRACT

Increasing the density of barium sulphate from 3.5 g/m³ density to 4.40 g/m³ density transforms it into a product of high qualities due to the reaction process to which it is subjected, additionally this invention helps to recycle elements that are intended for confinement, making the process highly environmentally friendly. Applications and use of barium sulfate include in the oil industry and the pharmaceutical industry. In the paint industry, barium sulfate is used as as a pigment with acid resistance. In the automotive industry, it is used to replace asbestos as frictional product in the manufacture of brake pads and in the glass industry as a flux and brightener. As protection in X-ray rooms due to its high density it can be used to absorb radiation. In the pharmaceutical industry, it is used as a contrast medium in digestive system imaging.

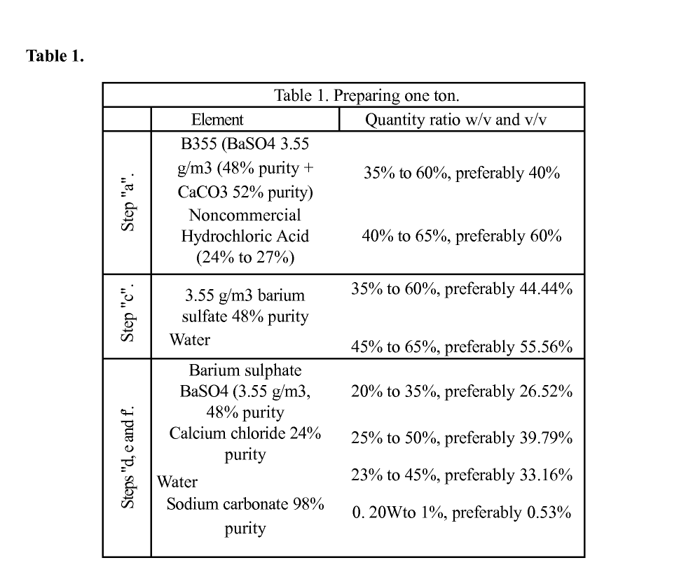

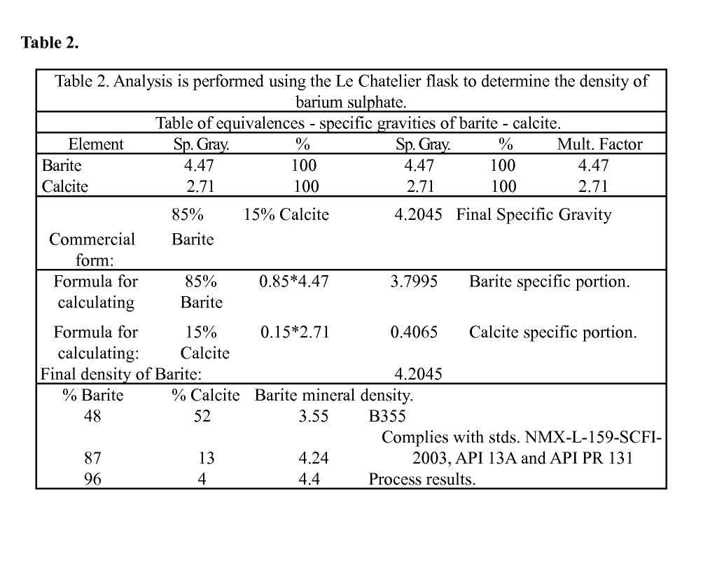

### CROSS-REFERENCE TO RELATED U.S. APPLICATIONS

Not applicable.

### STATEMENT FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a reactive process for obtaining barium sulfate and calcium chloride.

2. Description of Related Art Including Information Disclosed Under 37 CFR 1.97 and 37 CFR 1.98

The present invention provides a reactive process for separating from B355 (barium sulfate and calcium carbonate), as the result of the flotation process. Noncommercial hydrochloric acid is used (24% to 27% concentration). The reaction of B355 and hydrochloric acid results in calcium chloride and barium sulfate with a higher degree of purity and higher density. The process used for the two elements used prevents their confinement, due to the result of their transformation in the processes to which they are subjected.

### REFERENCES

U.S. Pat. No. 5,262,148: Process for preparing barium sulfate. Barium sulfate having a specific crystal structure and optical characteristics is disclosed. The crystals have a plate-like structure of which the aspect ratio is 5-100 and the ratio of the square of the circumference of the plate and the area of the orthogonal projection plane is 20:1-150:1. In a preferred embodiment, a thin film of 25 μm thickness with 20% by weight of the barium sulfate powder concentration has a scattering transmittance of 70% or greater and a total transmittance of 85% or greater. The cosmetic compositions to which the barium sulfate is incorporated exhibits excellent extendibility and adhesion to the skin and can effectively hide the spots or freckles on the skin. The cosmetic composition satisfies both the fine naked skin feeling and the skin covering effect, which have never been satisfied by conventional cosmetic compositions.

### BRIEF SUMMARY OF THE INVENTION

The reaction of B355 and hydrochloric acid results in calcium chloride and barium sulfate with a higher degree of purity and higher density.

### BRIEF DESCRIPTION OF THE SEVERAL VIEWS OF THE DRAWINGS

Table 1: Obtaining 4.40 g/m³ Barium Sulfate. Table 1 details the necessary amounts of the elements for obtaining barium sulphate according to each stage of the process object of this invention.

Table 2: Testing 4.40 g/m³ of Barium Sulfate. Table 2 shows results of analyses performed under the following parameters: NMX-L-159-SCFI-2003, API Specification 13A (SPEC 13A) and API RP 131.

### DETAILED DESCRIPTION OF THE INVENTION

The reactive process to obtain synthetic barium sulphate allows as much as 98% purity of the same with a density 4.40 g/m³, and calcium chloride (CaCl2) is also obtained at 24% concentration. It uses the following ingredients with the corresponding purity or concentration:
B355 (Barium Sulfate 67.12% with 3.00 g/m³ density+Calcium Carbonate 32.88% with 2.71 g/m³ density).
Hydrochloric Acid 24% to 27%.
Water.
Sodium Carbonate 70% to 98%, preferably 98%.

The process for obtaining synthetic barium sulfate and calcium chloride, object of the present invention comprises the following stages which occur within a reactor preferably made of fiberglass as described below:

(a) React B355 (barium sulfate and calcium carbonate) with noncommercial hydrochloric acid to elevate the purity of barium sulfate as a primary compound and obtain calcium chloride as a stock solution.

B355 25% to 80%, preferably at 40% w/v, is reacted with hydrochloric acid 10% to 80%, preferably at 60% v/v, for a period of 10 min to 60 min in a reactor, to obtain a stock solution containing calcium chloride with 24% concentration and barium sulfate free of calcium carbonate at 32.88% concentration, with a pH of 3 in the stock solution as shown in formula 1.

B355 (BaSO₄+CaCO₃)+2HCl BaSO₄+CaCl₂ Formula 1

(b) Filter the stock solution obtained in step a) through a press filter to obtain Calcium Chloride at 24% concentration and Barium Sulfate at 67.12% purity.

The stock solution is passed through the press filter preferably horn 14.15 L to 8,500 L per hour, calcium chloride at 24% and barium sulfate at 48% purity, the primary compound.

(c) The primary compound is rinsed in the reactor to remove traces of noncommercial hydrochloric acid from the compound of step (b).

The primary compound is rinsed, with ordinary water as necessary to remove the remaining noncommercial hydrochloric acid and it is allowed to remain in water for a period 5 to 60 min, preferably 30 min, water is released from the reactor, to obtain the parent compound, as shown in Formula 2.

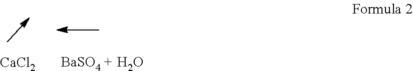

(d) Return to the reactor the stock solution obtained by filtration in the press filter in step (b).

The stock solution is returned to the reactor, which contains the primary compound rinsed in step (c), as shown in formula 3.

CaCl₂+BaSO₄ Formula 3

(e) Add sodium carbonate and water to the reactor, to make them react with the components of step (d) to obtain Barium Sulphate with a degree of purity of 67.12% and a density of 3.00 g/m³, and Calcium Chloride at 24% purity with a pH greater than or equal to 7.0.

The primary component at 10% to 45%, preferably 26.52% w/v, and the stock solution at 15% to 70%, preferably 39.79% v/v, are added to the reactor. Sodium carbonate 0.10% to 1%, preferably 0.53% v/v, which is 60% to 98% pure, preferably 98%, water is added at 13% to 45%, preferably 33.16% v/v, and the mixture is allowed to rest for a period of 5 min to 90 min, preferably 30 min; until the primary solution has a pH greater than or equal to 7.0 and the primary compound increases its purity up to 98% at a density 4.40 g/m³, as a result of the reaction with sodium carbonate at 98%. The reaction produces carbon dioxide, which is recovered and stored, as shown in Formula 4.

BaSO₄+CaCl₂+H₂O+NaCO₃═CO₂ Formula 4

(f) Filter the stock solution in a press filter and remove the primary component, the components of step (e) to obtain Barium Sulphate with a purity of 98% and 4.40 g/m³ density and Calcium Chloride with a pH greater than 7.0 at 24% concentration.

The stock solution is filtered by the press filter and placed in storage containers. The primary component is removed from the reactor, as shown in formula 5, to be dried and passed on to the grinder.

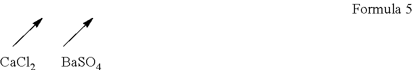

(g) Dry, mill and package the primary component, the component from step (f) to obtain Barium Sulfate at 98% purity and 4.40 g/m³ density.

The primary component is dried in a gas heated horizontal oven at a temperature of 150° C. to 300° C., preferably 150° C., for 20 min to 60 min, preferably 30 min. The primary component is introduced into a ball mill to pulverize it to 75 μm, 0.075 mm, 0.0029 in; the pulverized primary component is introduced in a silo for automatically dispensing the amount of 25 kg to 1.5 tons in a bag or double-layer paper bag.

4.40 g/m³ barium sulfate shall not undergo a densification of purity or density after the process. It will keep its higher qualities as if in its natural state. This ensures its use in various applications such as: oil wells, glass industry, automotive industry, pharmaceutical industry, paints and coatings industry, there will not by any physicochemical variations of barium sulfate in its processes, on the contrary it increases the optimization and cost reduction.

Method for Applying the Invention Since it is a 200 mesh fine powder, it always mixes with other elements depending on the intended use.

The main use of barium sulfate is in the oil industry.

It also has important applications in the paint industry as a pigment with acid resistance. It is used for obtaining the element barium.

In the automotive industry, to replace asbestos as frictional product in the manufacture of brake linings. In the glass industry, as a flux.

As protection in X-ray rooms, due to its high density it can absorb radiation. In some cases it substitutes lead.

In the medical industry, when ingested it is a contrast medium in digestive system imaging.

Calcium chloride in 10% pharmacological presentation, therapeutic group, mineral calcium supplement, in replacement of salts: when milk is pasteurized it loses calcium salts, so these salts are replaced with calcium chloride. Indications in emergencies: in cardiac arrhythmias associated with hypermagnesemia and hyperkalemia, severe hypocalcemia, magnesium sulfate or calcium antagonist poisoning, cardiopulmonary arrest unresponsive to adrenaline and suspected hypocalcemia. In the food industry, concrete mixtures, pH buffer and to adjust water hardness, additive in plastics and in fire extinguishers, in water treatment, exothermic solutions of calcium chloride are used in food and beverage cans that self-heat using the heat evolved, in the petroleum industry to increase density of brine-free solids, as expansive clay inhibitor in drilling fluids and as a desiccant.

1. A reactive process for obtaining synthetic barium sulfate and calcium comprising:
(a) reacting B355 (barium sulfate and calcium carbonate) with hydrochloric acid to elevate a purity of barium sulfate as a primary compound and to obtain calcium chloride as a stock solution;
(b) filtering through a press filter the stock solution obtained in step (a) to obtain calcium chloride at a 24% concentration and barium sulfate at a 67.12% purity;
(c) rinsing the primary compound in the reactor to remove traces of hydrochloric acid from the compound of step (b);
(d) returning to the reactor the stock solution obtained by filtration in the press filter in step (b);
(e) adding sodium carbonate and water to the reactor, so as to react with the components of step (d) and obtain barium sulphate with a degree of purity of 67.12% and a density of 3.00 g/m³ and calcium chloride at 24% purity with a pH greater than or equal to 7.0;
(f) filtering the stock solution in a filter press and removing the primary component, the components of step (e), to obtain barium sulphate with a purity of 98% and 4.40 g/m³ density and calcium chloride with a pH greater than 7.0 at 24% concentration; and
(g) drying, milling and packaging the primary component, the component from step (f) to obtain barium sulfate at 98% purity and 4.40 g/m³ density.

2. The reactive process for obtaining synthetic barium sulfate and calcium chloride of claim 1, where in step (a) B355 10 to 80% w/v is added along with hydrochloric acid 40 to 65% v/v, and reacted for a period of 10 to 60 minutes in a reactor to obtain a stock solution containing calcium chloride with 24% concentration and clean barium sulfate from calcium carbonate at 32.88% concentration, and a pH of 3 in the stock solution.

3. The reactive process for obtaining synthetic barium sulfate and calcium chloride of claim 2, wherein B355 is used at 40% w/v.

4. The reactive process for obtaining synthetic barium sulfate and calcium chloride of claim 2, wherein hydrochloric acid is added at 60% v/v.

5. The reactive process for obtaining synthetic barium sulfate and calcium chloride of claim 1, where in step (b) the primary solution is passed through the press filter at from 14.15 L to 8,500 L per hour so as to obtain calcium chloride at 24% sulfate and barium sulfate at 48% purity.

6. The reactive process for obtaining synthetic barium sulfate and calcium chloride of claim 1, where in step (c) the primary compound is rinsed with enough water to remove the remaining hydrochloric acid, said primary compound is allowed to rest along with the water, for a period of 5 to 60 minutes, then the water is released from the reactor, and the primary compound remains.

7. The reactive process for obtaining synthetic barium sulfate and calcium chloride of claim 6, where the primary compound is allowed to rest for 30 minutes.

8. The reactive process for obtaining synthetic barium sulfate and calcium chloride of claim 1, where in step (d) the filtered stock solution is by returned into the reactor which contains the rinsed primary compound.

9. The reactive process for obtaining synthetic barium sulfate and calcium chloride of claim 1, where in step (e) the primary component is added at 10% to 45% and the stock solution at 15% to 70% into the reactor along with sodium carbonate at 0.10% to 1%, which is 60% to 98% pure, water is added at 13% to 45%, and the aggregate is allowed to rest for a period of 5 to 90 minutes, until the primary solution attains a pH greater than or equal to 7.0 and the primary compound increases its purity up to 98% at a density 4.40 g/m³, as a result of the reaction with sodium carbonate at 98%; the reaction produces carbon dioxide, which is recovered and stored.

10. The reactive process for obtaining synthetic barium sulfate and calcium chloride of claim 9, where the primary component is added at 26.52% w/v and 48% purity.

11. The reactive process for obtaining synthetic barium sulfate and calcium chloride of claim 9, where the stock solution is added at 39.79% v/v and 24% purity.

12. The reactive process for obtaining synthetic barium sulfate and calcium chloride of claim 9, where sodium carbonate is added at 0.53% v/v and 98% purity.

13. The reactive process for obtaining synthetic barium sulfate and calcium chloride of claim 9, where sodium carbonate is added at 98% purity.

14. The reactive process for obtaining synthetic barium sulfate and calcium chloride of claim 9 where water is added at 33.16% v/v.

15. The reactive process for obtaining synthetic barium sulfate and calcium chloride of claim 9, where they are allowed to rest for 30 min.

16. The reactive process for obtaining synthetic barium sulfate and calcium chloride of claim 9, where they are allowed to rest, until the stock solution attains a pH greater than 7.0.

17. The reactive process for obtaining synthetic barium sulfate and calcium chloride of claim 9, where the primary compound increases in purity to 98%.

18. The reactive process for obtaining synthetic barium sulfate and calcium chloride of claim 9, where the primary compound increases its density to 4.40g/m³.

19. The reactive process for obtaining synthetic barium sulfate and calcium chloride of claim 9, where carbon dioxide is stored for final disposal.

20. The reactive process for obtaining synthetic barium sulfate and calcium chloride of claim 1, where in step (f) the stock solution is filtered in a press filter and the primary component is removed.

21. The reactive process for obtaining synthetic barium sulfate and calcium chloride of claim 20, where once after filtered, they are placed in storage containers for final disposal.

22. The reactive process for obtaining synthetic barium sulfate and calcium chloride of claim 20, where the primary component is removed from the reactor.

23. The reactive process for obtaining synthetic barium sulfate and calcium chloride of claim 1, where in step (g) the primary component is dried, milled and packaged.

24. The reactive process for obtaining synthetic barium sulfate and calcium chloride of claim 23, where the primary component is dried in a horizontal gas-heated oven at a temperature of 150° C. to 300° C., for a period of 20 min to 60 min.

25. The reactive process for obtaining synthetic barium sulfate and calcium chloride of claim 23, where the primary component is dried at 150° C.

26. The reactive process for obtaining synthetic barium sulfate and calcium chloride of claim 23, where the primary component is dried for 30 min.

27. The reactive process for obtaining synthetic barium sulfate and calcium chloride of claim 23, where the primary component is milled in a ball mill until pulverized.

28. The reactive process for obtaining synthetic barium sulfate and calcium chloride of claim 27, where they are pulverized to 75 μm, 0.075 mm, 0.0029 in.

29. The reactive process for obtaining synthetic barium sulfate and calcium chloride of claim 23, where the pulverized primary component is introduced into a silo to dispense automatically the amount of 25 kg to 1.5 tons in a sack or double layer paper bags.

30. Synthetic barium sulfate where being obtained through the process described in claim 1.

31. Calcium chloride where being obtained through the process described in claim 1.
